(19) United States
(12) Patent Application Publication
(10) Pub. No.: US 2021/0270972 A1
(43) Pub. Date: Sep. 2, 2021

(54) TIME-OF-FLIGHT CAMERA SYSTEM HAVING AN ADJUSTABLE OPTICAL POWER OUTPUT

(71) Applicant: PMDTECHNOLOGIES AG, Siegen (DE)

(72) Inventor: Samuel FREYWALD, Kreuztal (DE)

(21) Appl. No.: 17/253,158

(22) PCT Filed: Jun. 18, 2019
(86) PCT No.: PCT/EP2019/065943

§ 371 Date: Dec. 17, 2020

(30) Foreign Application Priority Data
Jun. 21, 2018 (DE) 10 2018 114 972.7
Dec. 6, 2018 (DE) 10 2018 131 182.6

(51) Int. Cl. G01S 17/894; G01S 7/4911; H04N 5/235; H04N 5/225

(52) U.S. Cl. CPC G01S 17/894; H04N 5/2256; H04N 5/2354; G01S 7/4911

(57) ABSTRACT

The disclosure relates to a time-of-flight camera comprising an illumination for emitting a modulated light, a light propagation time sensor, an illumination circuit for operating the illumination, a clock generator for generating a modulation signal, wherein the clock generator is designed in such a way that individual pulses of the modulation signal can be suppressed within a predetermined time interval.

### CROSS-REFERENCE TO RELATED APPLICATIONS

This application is a U.S. National Phase Application under 35 U.S.C. 371 of International Application No. PCT/EP2019/065943, filed on Jun. 18, 2019, which claims the benefit of German Patent Application No. 10 2018 114 972.7, filed on Jun. 21, 2018, and German Patent Application No. 10 2018 131 182.6, filed on Dec. 6, 2018. The entire disclosures of the above applications are incorporated herein by reference.

### FIELD

Such time-of-flight camera systems or 3D-TOF sensors relate to systems which obtain propagation time information from the phase shift of emitted and received radiation.

### BACKGROUND

This section includes background information related to the present disclosure which is not necessarily prior art.

PMD cameras comprising photonic mixer detectors (PMD), such as those described, for example, in DE 19704496 C2 and available from the company ‘IFM Electronic GmbH’ or ‘PMDTechnologies AG’ as frame grabbers O3D or as CamCube are particularly suitable as time-of-flight or 3D TOF cameras. The PMD camera allows, in particular, a flexible arrangement of the light source and the detector, which can be arranged both in a housing and separately. Of course, the term camera or camera system should also include cameras or devices comprising at least one receiving pixel.

### SUMMARY

This section provides a general summary of the disclosure, and is not a comprehensive disclosure of its full scope or all of its features.

The object of the disclosure is to improve the performance of time-of-flight camera systems without compromising eye safety.

The object is achieved in an advantageous manner by the method according to the disclosure and the system according to the preamble of the independent claims.

A method for operating a time-of-flight camera system is advantageously provided, wherein the time-of-flight camera system is designed for a distance measurement based on a phase shift of emitted and received modulated light,
wherein a first modulation signal is generated for a propagation time sensor and a second modulation signal is generated for illumination, and wherein both modulation signals comprise switch-on pulses and pauses,
wherein the illumination for a distance measurement is operated for a predetermined emission duration,
wherein a maximum emission energy of the illumination for the predetermined emission duration is fixed and the emission duration is divided into pulse groups with a predetermined group duration,
wherein the maximum emission energy for each pulse group is obtained from the ratio of the maximum emission energy and the number of pulse groups within the emission duration according to:

$${E}_{max , IG} = \frac{{E}_{max , int}}{{n}_{IG}} ,$$

wherein the emission energy for the entire emission duration is set by switching on or off power on pulses within each pulse group in the modulation signal M_{0,red} for the illumination.

This procedure has the advantage that the power within each pulse group can be set linearly.

It is also useful when switching on or off of pulses for energy adjustment is achieved in that the pulse group is formed by a binary word or that it is determined by use of a counter which pulses within a pulse group are to be switched on or off.

It is particularly advantageous if initially in an initial operation and/or in a production phase of the time-of-flight camera system a part of the pulses within the pulse group are switched off.

It is also advantageous if in the production phase the emission energy is set with regard to a maximum emission energy or a predetermined 3D performance.

In a further embodiment it is provided that the emission energy is controlled during operation and regulated to a predetermined target value.

Moreover, a time-of-flight camera system comprising an illumination for emitting modulated light and a propagation time sensor for receiving the light emitted and reflected by a scene and a modulator for generating a modulation signal is advantageously provided, wherein the time-of-flight camera system is designed to carry out one of the aforementioned methods.

Furthermore, the system may include a device for generating a binary word for forming pulse groups with switched on and/or switched off pulses.

Or the system is equipped with a counter which is designed in such a way that pulses in the pulse groups are switched on or switched off on the basis of preset-table counter readings.

It is particularly useful to provide a monitoring device for monitoring the emitted energy, which is designed in such a way that the emitted energy is regulated to a predetermined target value by switching pulses on and/or off in each pulse group.

It is particularly advantageous to use one of the aforementioned methods or devices in a production line in such a way that the emitted energy is adjusted with regard to a predetermined 3D performance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The disclosure is explained in more detail below on the basis of exemplary embodiments with reference to the drawings.

In the drawings:

FIG. 1 schematically shows a time-of-flight camera system;

FIG. 2 shows a modulated integration of generated charge carriers;

FIG. 3 shows a pulse group with a duration of 1 μs for a 50 MHz modulation signal;

FIG. 4 shows a pulse group with suppressed pulses;

FIG. 5 shows a pulse group with a duration of 5 μs with suppressed pulses;

FIG. 6 shows a pulse sequence over the entire integration time;

FIG. 7 shows a pulse sequence with a duration of 5 μs with 250 single pulses;

FIG. 8 shows a sequence of pulse groups over the integration or switch-on time;

FIG. 9 shows a first exemplary embodiment in which the camera and the illumination are modulated differently; and

FIG. 10 shows a second exemplary embodiment comprising a counter.

### DETAILED DESCRIPTION

Example embodiments will now be described more fully with reference to the accompanying drawings.

In the following description of the preferred embodiments, the same reference symbols designate the same or comparable components.

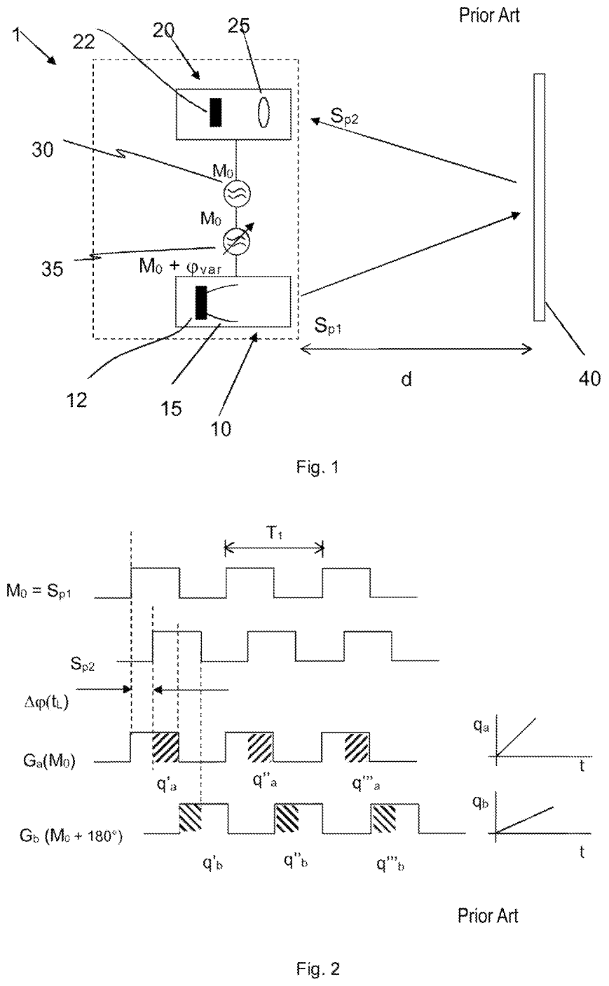

FIG. 1 shows a measurement situation for an optical distance measurement with a time-of-flight camera, as is known, for example, from DE 19704496 A1.

The time-of-flight camera system 1 comprises an emission unit or an illumination module 10 with an illumination 12 and an associated beam-shaping optics 15 and a receiving unit or time-of-flight camera 20 with receiving optics 25 and a propagation time sensor 22. The propagation time sensor 22 comprises at least one time-of-flight pixel, preferably also a pixel array and is designed in particular as a PMD sensor. The receiving optics 25 typically consists of several optical elements in order to improve the imaging properties. The beam-shaping optics 15 of the emission unit 10 can be designed, for example, as a reflector or a lens optics. In a very simple embodiment, it is also possible, where appropriate, to dispense with optical elements on both the receiving and transmitting sides.

The measuring principle of this arrangement is based on the fact that starting from the phase shift of the emitted and received light, the propagation time of the received light and thus the distance travelled by the received light can be determined. For this purpose, the light source 12 and the propagation time sensor 22 are applied together via a modulator 30 with a specific modulation signal M₀ with a base phase φ₀. In the example shown, moreover, between the modulator 30 and the light source 12 a phase shifter 35 is provided, by means of which the base phase φ₀ of the modulation signal M₀ of the light source 12 can be shifted by defined phasings φᵥₐᵣ. For typical phase measurements, preferably phasings of φᵥₐᵣ=0°, 90°, 180°, 270° are used.

According to the set modulation signal, the light source 12 emits an intensity-modulated signal Sₚ₁ with the first phasing p1 or p1=φ₀+φᵥₐᵣ. This signal Sₚ₁ or the electromagnetic radiation is reflected in the illustrated case by an object 40 and hits due to the distance traveled correspondingly phase-shifted Δφ(t_{L}) with a second phasing p2=φ₀+Δφ(t_{L}) as received signal Sₚ₂ onto the propagation time sensor 22. In the propagation time sensor 22 the modulation signal M₀ is mixed with the received signal Sₚ₂, wherein the phase shift or the object distance d is determined from the resulting signal.

As an illumination source or light source 12 preferably infrared light emitting diodes are suited. Of course, other emission sources in other frequency ranges are conceivable, in particular light sources in the visible frequency range come into consideration.

The basic principle of the phase measurement is shown schematically in FIG. 2. The upper curve shows the time profile of the modulation signal M₀ with which the illumination 12 and the propagation time sensor 22 are driven. The light reflected from the object 40 hits onto the propagation time sensor 22 with a phase shift Δφ(t_{L}) in accordance with its propagation time t_{L}. The propagation time sensor 22 accumulates the photonically generated charges q over several modulation periods in the phasing of the modulation signal M₀ in a first accumulation gate Gₐ and in a phasing M₀+180° phase shifted by 180° in a second accumulation gate G_{b}. The phase shift Δφ(t_{L}) and thus a distance d of the object can be determined from the ratio of the charges qa, qb accumulated in the first and second gates Gₐ, G_{b}.

All components of a 3D ToF camera system such as illumination, illumination driver, 3D-ToF-imager, lens, etc. have material and manufacturing tolerances. For a 3D ToF camera system these tolerances have an effect in different performances of the individual camera system. In addition, when using lasers in a 3D ToF camera system, the permissible limits of the optical output power with regard to eye safety in accordance with the applicable guidelines and standards must be taken into account.

The object of the disclosure is to compensate for power variations of individual cameras. Here, the optical output power should be adjustable as finely and linearly as possible.

The eye safety standards provide that pulse sequences or pulse groups in the wavelength range between 400 nm and 1050 nm below 5 μs can be summed up. For these pulse lengths the power setting is linear. Pulse sequences of a duration of more than 5 μs are treated with a factor to the fourth power depending on the pulse sequence length. An adjustment of the power, for example by use of a pulse width modulation, which also allows pulses longer than 5 μs, would be highly non-linear and very complex.

According to the disclosure it is therefore provided for the power setting to consider only pulses shorter than 5 μs and to set a so-called duty cycle for the power setting. Since the duty cycle affects each single pulse, the power within a pulse group IG, the time length or the group time t_{IG} of which is less than or equal to 5 μs, can be set so that the power adjustment takes place linearly in accordance with eye safety standards. Thus, the duty cycle adjustment can be used for the linear adjustment of the optical output power (I). Here, the following applies:

Energy:

Q=∫_{Δt}ϕdt [J]

Power:

$$ϕ = \frac{d Q}{d t} \qquad [ W ]$$

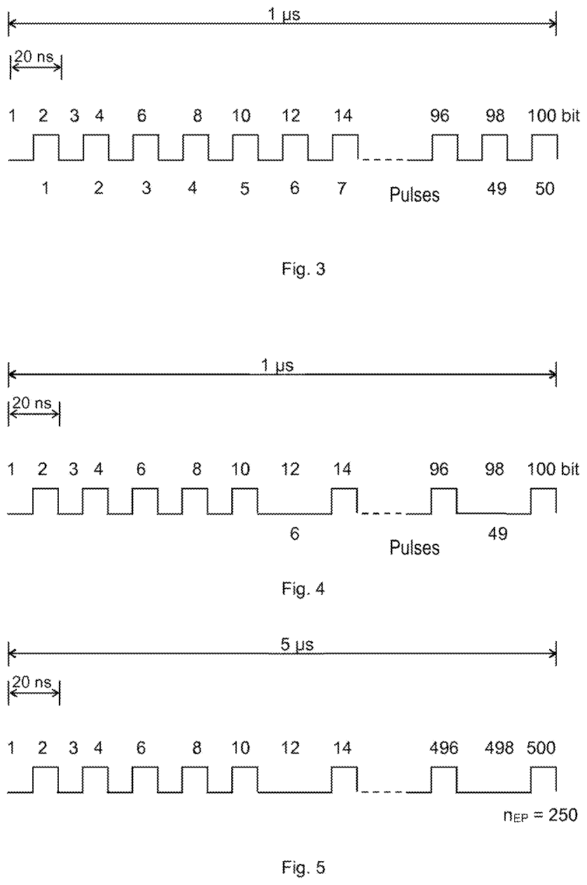

FIG. 3 shows an example of a pulse group of a modulation signal with a modulation frequency of 50 MHz. The period of the modulation signal is then 20 ns. The modulation can in principle also be considered as a binary word, so that a period of the square-wave signal can also be described with the binary word 01, wherein in the present example each bit of this binary word has a time length of 10 ns. The modulation signal shown has 50 switch-on pulses or single pulses EP, n_{EP} with a time length of 1 μs and can thus be described in the form of a binary word with a bit length of 100.

According to the disclosure, it is now provided for power adjustment to suppress individual switch-on pulses or pulses in a predetermined pulse group. In the example according to FIG. 4 it is provided to suppress the 12th and 98th bit or the 6th and 49th pulse, for example by outputting a corresponding binary word. This means that the power output in this pulse group is reduced by 2/50, i.e. by 4%.

$${Q}_{r e d} = \frac{Pulse {s}_{sup p r e s s e d}}{Pulses} = \frac{{n}_{u}}{n} = \frac{2}{50} = 4 \%$$

Here, for power reduction it is irrelevant which two pulse bits or switch-on pulses within the pulse group are switched off. Thus, it is also conceivable to switch off the first or the last two pulses.

Particularly advantageously the suppressed bits or pulses can also be selected at random.

Preferably the maximum time length of the pulse group and, accordingly, of the binary word, is adapted to the corresponding standard specification. As already described, pulse groups up to a time length t_{IG,max} of 5 μs can be combined as a single pulse for a wavelength range between 400 nm and 1050 nm.

In the example shown in FIGS. 3 and 4 the 50 MHz modulation signal could be combined into a pulse group of 250 pulses n_{EP} and described as a 500 bit word, as shown in FIG. 5. Switching off 2 bits in this block would then correspond to a power reduction of 2/250=0.8%.

$${Q}_{r e d} = \frac{{n}_{u}}{n} = \frac{2}{250} = 0.8 \%$$

By use of the size of the selected pulse group, thus, the possible resolution of the power setting can be specified.

If due to technical constraints only binary words of a fixed length are available, a cut-off frequency must be considered at which the time length T_{Binw} of the binary word exceeds the maximum time length t_{IG,max} that can be summed to a single pulse length.

T_{Binw}=n_{Bit}·t_{Bit}≤5 μs=t_{IG,max}

Then, for the period Tₚₑᵣ of the modulation signal, the length of which is made up of two bits 01, the following applies:

$${n}_{p e r} \cdot {T}_{p e r} = \frac{{n}_{B i t}}{2} \cdot {T}_{p e r} \leq 5 μs$$

$${T}_{per , max} \leq \frac{2 \cdot 5 μs}{{n}_{B i t}} \\ f \geq {f}_{g r e n z} = \frac{1}{{T}_{per , max}} = \frac{{n}_{B i t}}{2 \cdot 5 μs}$$

If, for example, only one binary word with a length of 128 bits is available, the following boundary conditions apply:

$${T}_{per , max} \leq \frac{25 μs}{128} = 78 , 125 ns$$

$$f \geq {f}_{g r e n z} = \frac{1}{{T}_{per , max}} = \frac{128}{2 \cdot 5 μs} = 12 , 8 MHz$$

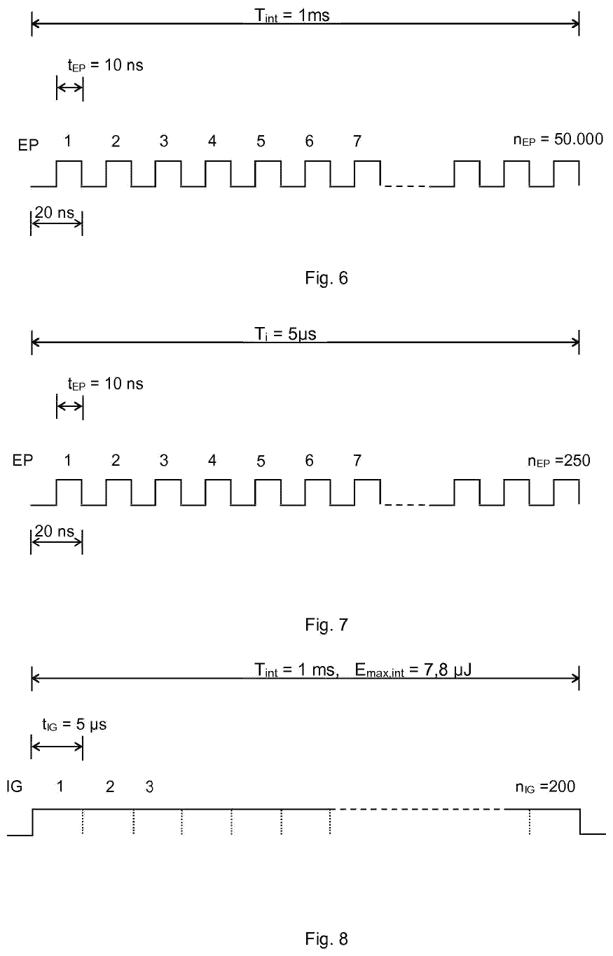

However, the total emission duration tᵢₙₜ of a time-of-flight camera is not limited to a 5 μs group, but depends on the integration time or duration tᵢₙₜ of the propagation time sensor required for the task. In FIG. 6 an integration time of 1 ms is shown as an example. With a modulation signal of 50 MHz, 50,000 single pulses n_{EP} occur during this period.

As already shown in FIG. 5 and shown again in FIG. 7, according to standard specification single pulses within a period of 5 μs can be combined to one pulse group IG and considered as a common pulse. In the selected example of 50 MHz, the 5 μs pulse group has 250 single pulses n_{EP}.

As shown in FIG. 8, the total emission duration tᵢₙₜ can then be divided into 200 pulse groups IG.

The basic idea of the disclosure is, as already described, to adjust the emitted power based on switching on and off pulses in the pulse groups.

According to regulations for eye safety for a class 1 laser, the total energy E_{max,int} with an emission duration of 1 ms need not exceed a value of 7.85 μJ. According to the disclosure, it is now provided to distribute this total energy E_{max,int} evenly over the 5 μs pulse groups possible during the emission duration tᵢₙₜ. I.e., in the example according to FIG. 8

$${E}_{max , IG} = \frac{{E}_{max , int}}{{n}_{IG}} \\ {E}_{5 μ s} = \frac{{E}_{1 m s}}{{n}_{IG}} = \frac{7 , 85 μJ}{200} = 39 μJ$$

this results in a maximum pulse group energy E_{max,IG} of 39 nJ.

According to the disclosure, for adjusting or regulating the energy 5 μs pulse groups are considered. Preferably, the energy of the emitted power is set to 80% to 90% of the upper limit with respect to eye safety, i.e., according to the above example between 31 and 35 nJ. Thus there is also an adjustment scope for a rise.

Such a procedure is important in particular in the production process when the time-of-flight cameras are set to a constant 3D performance. In this way, scatterings in production due to the technical design can be compensated for in a simple manner. For example, the optical elements can vary in their light transmission, the emission geometry can have different characteristics, the quantum efficiency of the propagation time sensor can vary, etc.

As a result, time-of-flight cameras with the same emission energy have different 3D performances, which, for example, appear due to different measurement accuracies.

According to the disclosure, it is therefore provided to optimize the time-off-light camera systems preferably not with regard to a maximum possible emission power, but rather with regard to a constant 3D performance. For example, during an initial calibration in a production line in order to ensure consistent performance the emitted power can be reduced, if appropriate, although the eye safety limit value has not been exceeded.

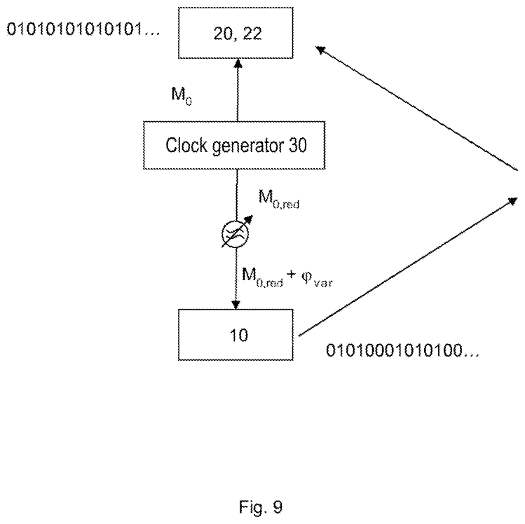

FIG. 9 shows a possible embodiment in which the modulator 30 or clock generator 30 specifies two modulation signals or two binary words, i.e. a complete binary word M₀ without suppressed pulses, by means of which the camera 20 or the propagation time sensor 22 is operated, and a second reduced binary word M_{0,red} with suppressed pulses by means of which the illumination 10 or the light sources is operated.

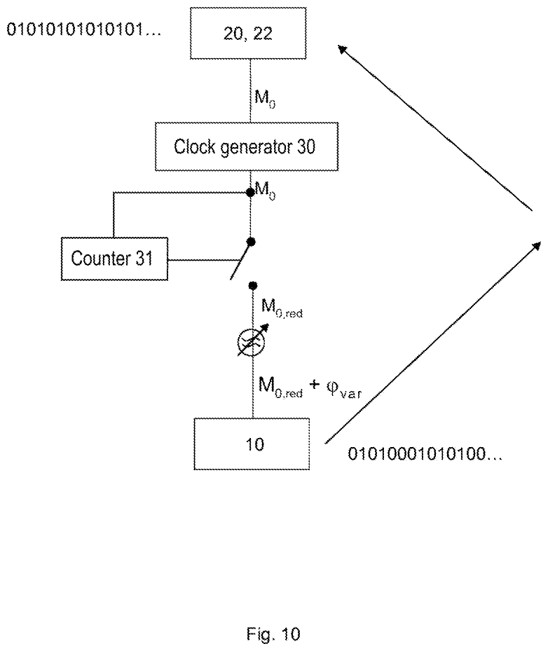

In a further embodiment according to FIG. 10, instead of specifying dedicated binary words, the pulses of the clock generator 30 are counted by means of a counter 31, wherein the counter 31 switches off one or more pulses after a predetermined number of pulses so that as a result for each pulse group IG a reduced binary word or a reduced modulation signal is provided and each pulse group IG is below the maximum pulse group energy E_{max,IG}.

Furthermore, it can be provided that at an initial commissioning the time-off-light camera system is initially operated with a reduced binary word so that the energy E initially emitted falls within a range of 80% to 90% of the maximum permissible energy E_{max,int}. In a production phase, the power can then be increased by activating suppressed pulses and decreased by suppressing or deactivating active pulses.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A method for operating a time-of-flight camera system, wherein the time-of-flight camera system is configured for a distance measurement on the basis of a phase shift of emitted and received modulated light,
wherein a first modulation signal for a propagation time sensor and a second modulation signal for an illumination are generated and both modulation signals have switch-on pulses and pauses,
wherein the illumination is operated for a distance measurement for a predetermined emission duration,
wherein a maximum emission energy of the illumination is specified for the predetermined emission duration and the emission duration is divided in pulse groups with a specified group duration,
wherein the maximum emission energy for each pulse group is obtained from the ratio of the maximum emission energy and the number of pulse groups within the emission duration according to:
$${E}_{max , IG} = \frac{{E}_{max , int}}{{n}_{IG}}$$
wherein the emission energy for the entire emission duration is set by switching on or off switch on pulses in the modulation signal for the illumination within each pulse group.

2. The method according to claim 1, wherein the switching on or off of pulses for energy setting is achieved in that the pulse group is formed by a binary word, or that by use of a counter it is determined which pulses within a pulse group are switched on or off.

3. The method according to claim 1, wherein initially in an initial operation and/or in a production phase of the time-of-flight camera system a part of the pulses within the pulse group are switched off.

4. The method according to claim 3, wherein in the production phase the emission energy is set with regard to a maximum emission energy or a predetermined 3D performance.

5. The method according to claim 1, wherein the emission energy is controlled during the operation and adjusted to a predetermined target value.

6. A time-of-flight camera system comprising an illumination for emitting modulated light and a propagation time sensor for receiving the light emitted and reflected by a scene, and comprising a modulator for generating a modulation signal, wherein the time-of-flight camera system is configured to carry out one of the aforementioned methods.

7. The time-of-flight camera system according to claim 6, comprising a device for generating a binary word for forming pulse groups with switched on and/or switched off pulses.

8. The time-of-flight camera system according to claim 6, comprising a counter which is configured such that pulses in the pulse groups are switched on or off on the basis of predeterminable counter readings.

9. The time-of-flight camera system according to claim 6, comprising a monitoring device for monitoring the emitted energy, which is configured such that the emitted energy is adjusted to a predetermined target value by switching on and/or switching off pulses in each pulse group.

10. (canceled)

11. A method of adjusting emitted energy in a production line with regard to a predetermined 3D performance utilizing the time-of-flight camera system of claim 6.

12. A method of adjusting emitted energy in a production line with regard to a predetermined 3D performance utilizing the method of operating a time-of-flight camera system of claim 1.
